(19) United States
(12) Patent Application Publication
(10) Pub. No.: US 2016/0182648 A1
(43) Pub. Date: Jun. 23, 2016

(54) TECHNIQUES FOR TEMPORARILY DISABLING WIRELESS AUTOMATIC-CONNECTIONS

(71) Applicants: TAL DAVIDSON, Petach Tikva (IL); PAZ PENTELKA, Natania (IL); MICHAEL GLIK, Kfar Saba (IL); ELDAD LEVY, Nes Ziona (IL); YOAV GAL, EINAT (IL)

(72) Inventors: TAL DAVIDSON, Petach Tikva (IL); PAZ PENTELKA, Natania (IL); MICHAEL GLIK, Kfar Saba (IL); ELDAD LEVY, Nes Ziona (IL); YOAV GAL, EINAT (IL)

(21) Appl. No.: 14/581,834

(22) Filed: Dec. 23, 2014

(51) Int. Cl. H04L 29/08

(52) U.S. Cl. CPC H04L 67/143; H04L 67/141

(57) ABSTRACT

Various embodiments are generally directed to an apparatus, method and other techniques to disable an automatic-connection operation to establish a communication link between a mobile computing device comprising a communication interface and a computing device using the communication interface until a detection of at least one reset event. Further, various embodiments may detect at least one reset event, reset the automatic-connection operation based on the detection of at least one reset event, and perform the automatic-connection operation to automatically establish the communication link between the mobile computing device and the other computing device using the communication interface.

### TECHNICAL FIELD

Embodiments described herein generally relate to techniques for establishing connection between devices. More specifically various embodiments may be directed to performing and controlling automatic-connection operations to establish communication links.

### BACKGROUND

Wireless capability allows a variety of devices to communicate with each other adding to the mobility of users. A computing device, such as a mobile computing device, may be used with various peripherals which are not wired together, but rather communicate using wireless communications. A connection may be made between the mobile computing device and one or more of the peripherals. Thus, as operations are performed by the mobile computing devices, information may be communicated between the various peripherals.

### BRIEF DESCRIPTION OF THE DRAWINGS

FIG. 1 illustrates an embodiment of a computing system.

FIGS. 2A-2E illustrate embodiments of a computing system.

FIG. 3 illustrate an embodiment of a logic flow diagram.

FIG. 4 illustrates an embodiment of a sequence diagram.

FIG. 5 illustrates an embodiment of a mobile computing device.

FIG. 6 illustrates an embodiment of a second logic flow diagram.

FIG. 7 illustrates an exemplary embodiment of a computing system.

FIG. 8 illustrates an exemplary embodiment of a computing architecture.

### DETAILED DESCRIPTION

Various embodiments are generally directed to an apparatus, system and method to perform, control and disable automatic-connection operations between devices. An automatic-connection operation may be conducted by a device to automatically connect with another device when the other device is detected in an automatic-connection area, by wireless signals for example. During an automatic-connection operation various information, including identification information, security information, protocol information, link information, and so forth may be communication between the devices such that a communication link is established. In some embodiments, the communication link may be established between the devices in accordance with one or more protocols, including one or more of the Institute of Electrical and Electronics Engineers (IEEE) 802.11 standards for wireless local area networks (WLANs), for example IEEE 802.11-2012 Revision of IEEE Standard 802.11-2007, Mar. 29, 2012 also including any amendments, such as IEEE 802.11ad as defined by the Wireless Gigabit Alliance (WiGig) and Wi-Fi Alliance groups. In some embodiments, the one or more protocols may include any peer-to-peer protocol.

In some embodiments, the automatic-connection operation may be disabled and a communication link will not be established between the devices. More specifically, even if a device detects another device via one or more detection means, the device will not automatically connect with the other device. In embodiments, the automatic-connection operation may be disabled on a device such that it does not automatically connect with any devices, or may be disabled such that the device does not connect with particular devices. Various embodiments are not limited in this manner. Moreover, the automatic-connection operation may be disabled in a number of different ways including a user input or a disabling trigger events.

Various embodiments may also be directed to resetting or enabling the automatic-connection operation on a device based on the occurrence of one or more resetting events. For example, an automatic-connection may be enabled (or re-enabled) on a device to automatically connect with another device based on a change of location of either device, a change in power states of either device, a change in modes of operation of either device, a particular time of day, a particular location, the elapse of a time period, and so forth. Once at least one of these resetting events occurs, the automatic-connection operation may be enabled and a communication link may be established between the devices. Various embodiments are not limited in this manner, for example the automatic-connection operation may be enabled or reset via a user input. These and other details will become more apparent with the following description.

Various embodiments also relate to an apparatus or systems for performing these operations. This apparatus may be specially constructed for the required purpose or it may include a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

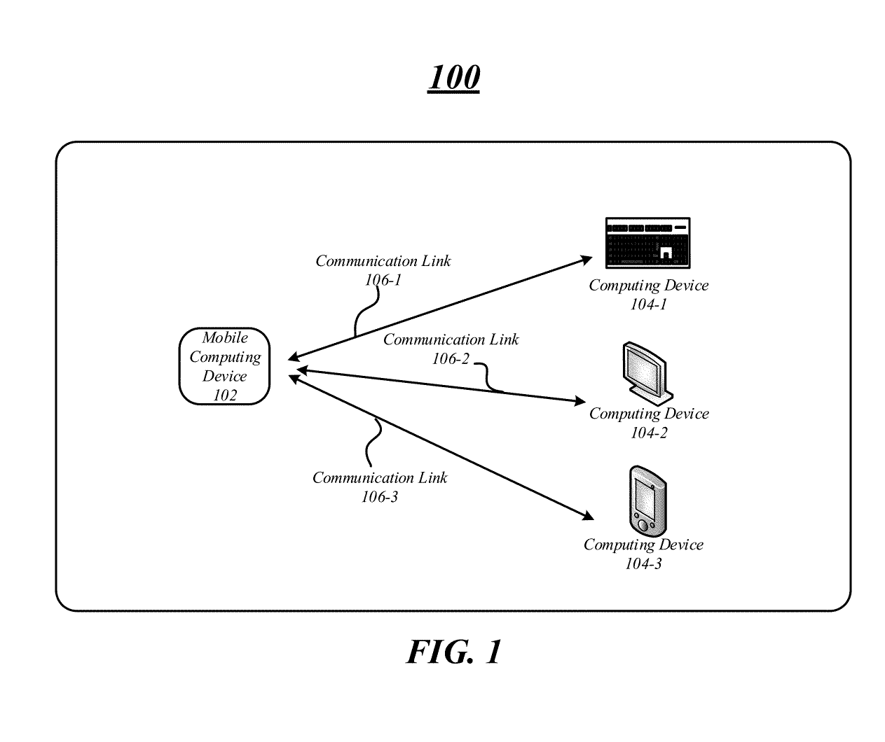

FIG. 1 illustrates an embodiment of a computing system 100 to process information over one or more communication links between devices. FIG. 1 illustrates computing system 100 having a mobile computing device 102 coupled with a computing devices 104-1, 104-2, and 104-3 via communication links 106-1, 106-2, 106-3, respectively. Although FIG. 1 only illustrates the mobile computing device 102 coupled with and communicating with three computing devices 104-1 through 104-3, the mobile computing device 102 may communicate with any number of computing devices 104 over any number of communication links 106.

In various embodiments, the mobile computing device 102 may be any type of computing device that is capable of processing information and instructions including information received via wireless and wired communication links. For example, the mobile computing device 102 may be any type of computing device, including a personal digital assistant, a smart phone, a cellular telephone, a handset, a one-way pager, a two-way pager, a messaging device, a computer, a laptop computer, a notebook computer, a handheld computer, a tablet computer, an electronic-reader, a network appliance, a web appliance, multiprocessor systems, processor-based systems, or any combination thereof. The embodiments are not limited in this context.

Moreover, computing device 104 may be any type of computing device capable of processing information and instructions. A computing device 104 may be a personal digital assistant, a smart phone, a cellular telephone, a handset, a one-way pager, a two-way pager, a messaging device, a computer, a laptop computer, a notebook computer, a handheld computer, a tablet computer, an electronic-reader, a network appliance, a web appliance, multiprocessor systems, processor-based systems, an access point, or any combination thereof. Furthermore, a computing device 104 may be a peripheral device such as a keyboard, a mouse, one or more speakers, a monitor, a projector, a docking station or any other device capable of communicating over wired and wireless communication links.

In some embodiments, mobile computing device 102 may communicate information in packets, frames, and so forth with one or more of the computing devices 104-1 through 104-3 over a communication links 106-1 through 106-3, respectively. The communication links 106-1 through 106-3 may be any type of link including a wireless or wired link and are capable of communicating information via one or more standards. For example, mobile computing device 102 may communicate over a communication link 106 with a computing device 104 in accordance with one or more Institute of Electrical and Electronics Engineers (IEEE) 802.11 standards for wireless local area networks (WLANs), such as IEEE 802.11-2012 Revision of IEEE Standard 802.11-2007, Mar. 29, 2012 also including any amendments, such as IEEE 802.11ad as defined by the Wireless Gigabit Alliance (WiGig) and Wi-Fi Alliance groups. In various embodiments, the information communicated over the communication link 106 may be any type of information including video information, audio information, HyperText Markup Language (HTML) information, webpage information, Internet information, multimedia information, television information and so forth. Various embodiments are not limited in this manner.

In some embodiments, the mobile computing device 102 is operable to automatically connect with a computing device 104 via a communication link 106. For example, once the mobile computing device 102 enters an automatic-connection area, or any location where the mobile computing device 102 can wirelessly detect the computing device 104, the mobile computing device 102 can perform an automatic-connection operation. During an automatic connection operation, the mobile computing device 102 may exchange information with the computing device 104 to establish a communication link 106 to communicate information.

The automatic-connection operation may occur transparently and without user intervention in some embodiments. For example, a user is not required to input any information including an acknowledgement, password and so forth for the communication link 106 to be established between the mobile computing device 102 and another computing device 104. However and in some embodiments, a user may have preconfigured an automatic-connection profile such that the mobile computing device 102 automatically connects with a computing device 104 once it is in range.

Various embodiments are not limited to the mobile computing device 102 establishing a single communication link 106 with a computing device 104 via an automatic-connection operation. For example, an automatic-connection profile may be established for any number of computing devices 104 and when the mobile computing device 102 is in range of another computing device 104, the mobile computing device 102 may perform an automatic-connection operation to connect with the other computing device 104. Further, FIG. 1 illustrates mobile computing device 102 communicating with three computing devices 104-1 through 104-3, each of the communication links 106-1 through 106-3 may be established via an automatic-connection operation. Various embodiments are not limited in this manner.

In some embodiments, an automatic-connection operation may be canceled or temporarily suspended such that an automatic-connection operation is not executed when a mobile computing device 102 detects a computing device 104. For example, if the automatic-connection operation is disabled and a mobile computing device 102 is detected in an automatic-connection area, the mobile computing device 102 will not establish a communication link and session with the computing device 104.

In some embodiments, the automatic-connection operation can be canceled or suspended when the mobile computing device 102 is in a communication session with a computing device 104. In these embodiments, the mobile computing device 102 may disconnect and break the communication link 106 between the mobile computing device 102 and the computing device 104. As will be discussed in more detail below, the automatic-connection operation may not be enabled or re-enabled until some trigger or reset event occurs, such as either device exiting and/or entering an automatic-connection area, either device changing a mode of operation, either device changing a power state, an expiration of a time period, and so on.

In some embodiments, the mobile computing device 102 may disable the automatic-connection operation with a single particular computing device 104, with any number of computing devices 104 or with all of the computing devices 104. When the mobile computing device 102 disables automatic-connection with less than all of the computing devices 104, the mobile computing device 102 may continue to perform an automatic-connection operation when it detects the presence of another mobile computing device 104 having automatic-connection operation enabled.

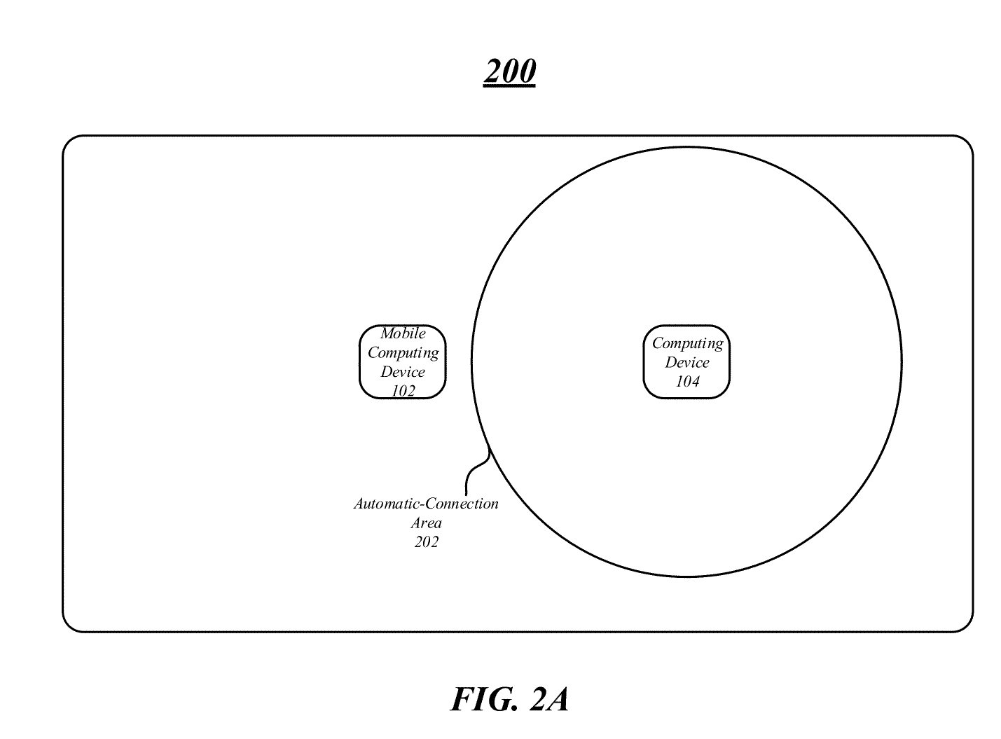

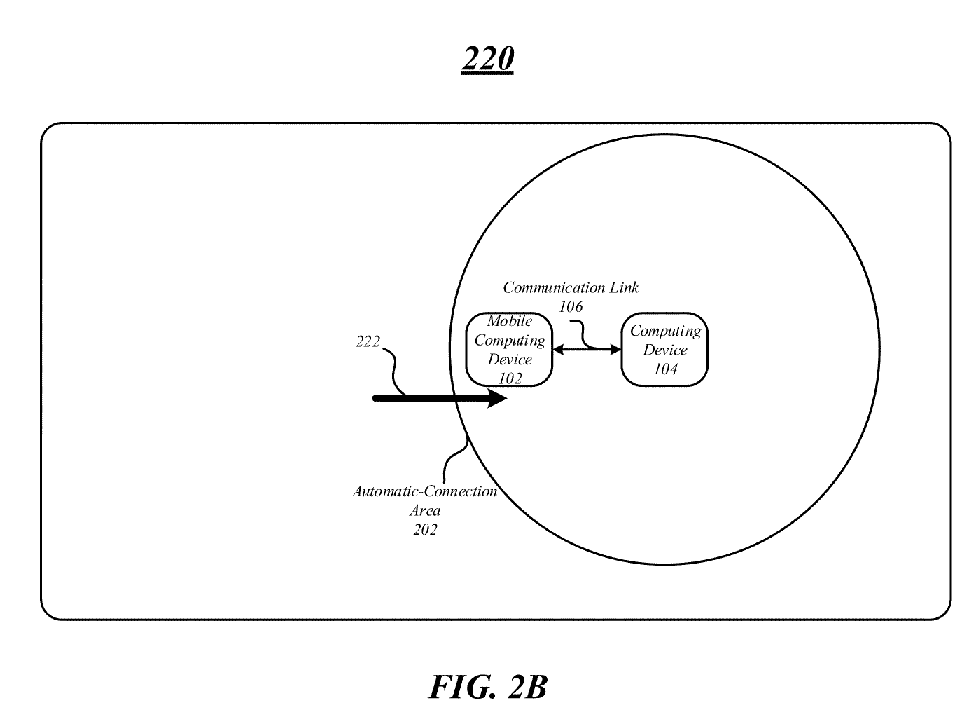

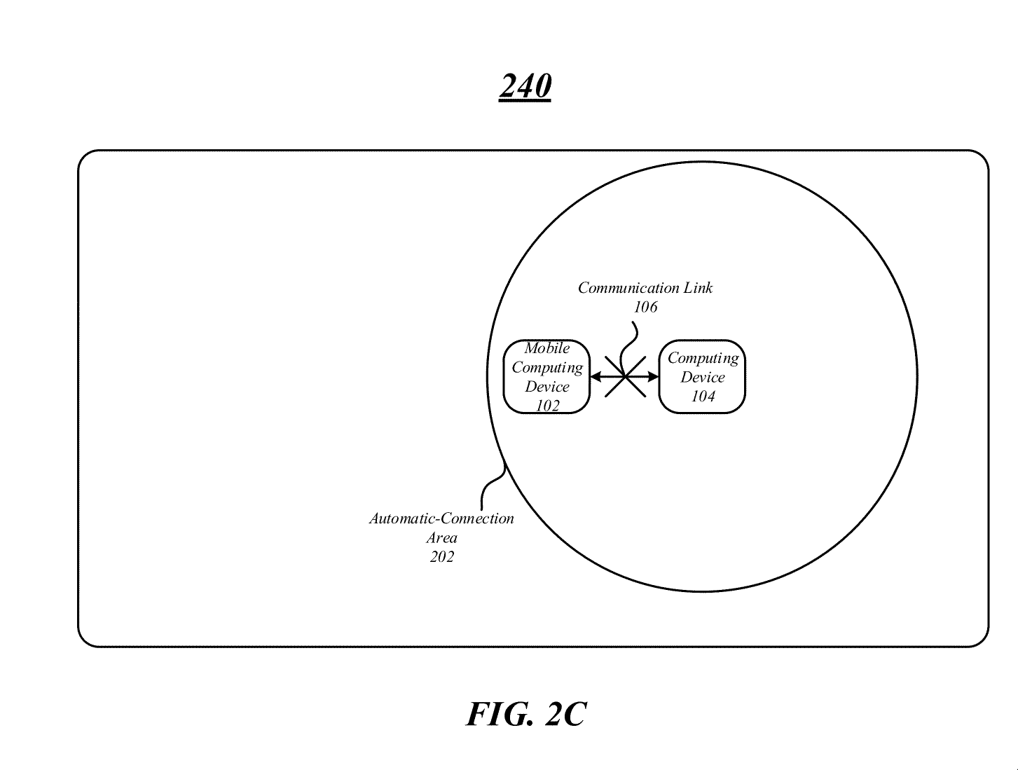

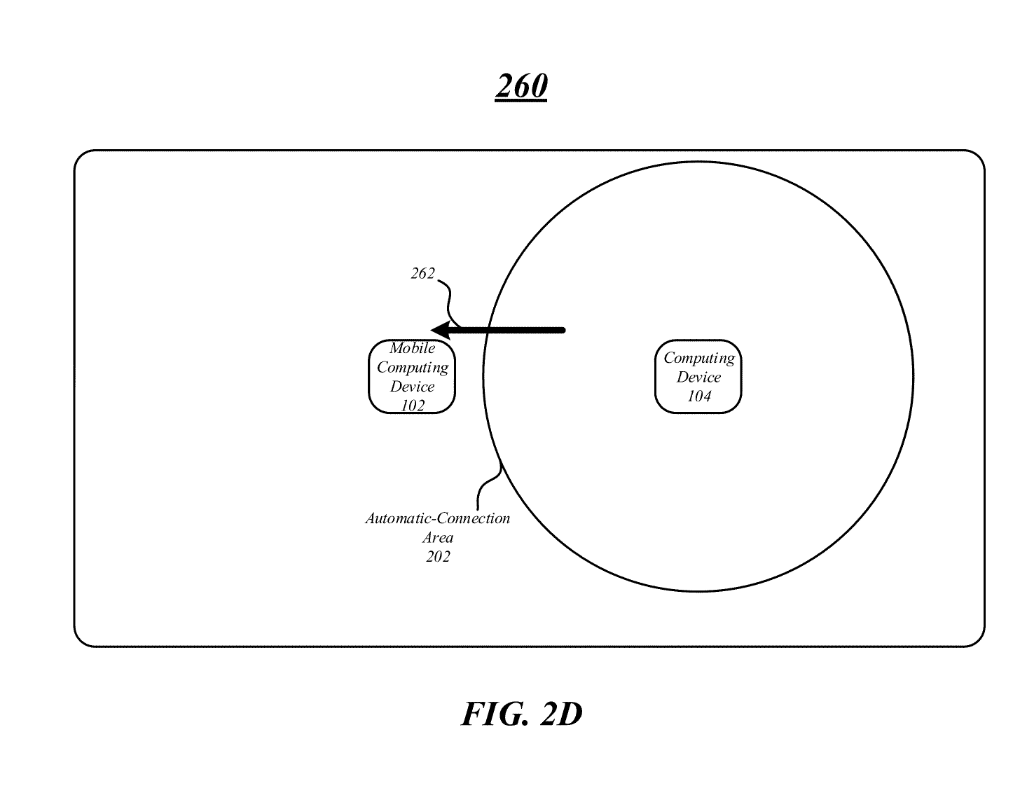

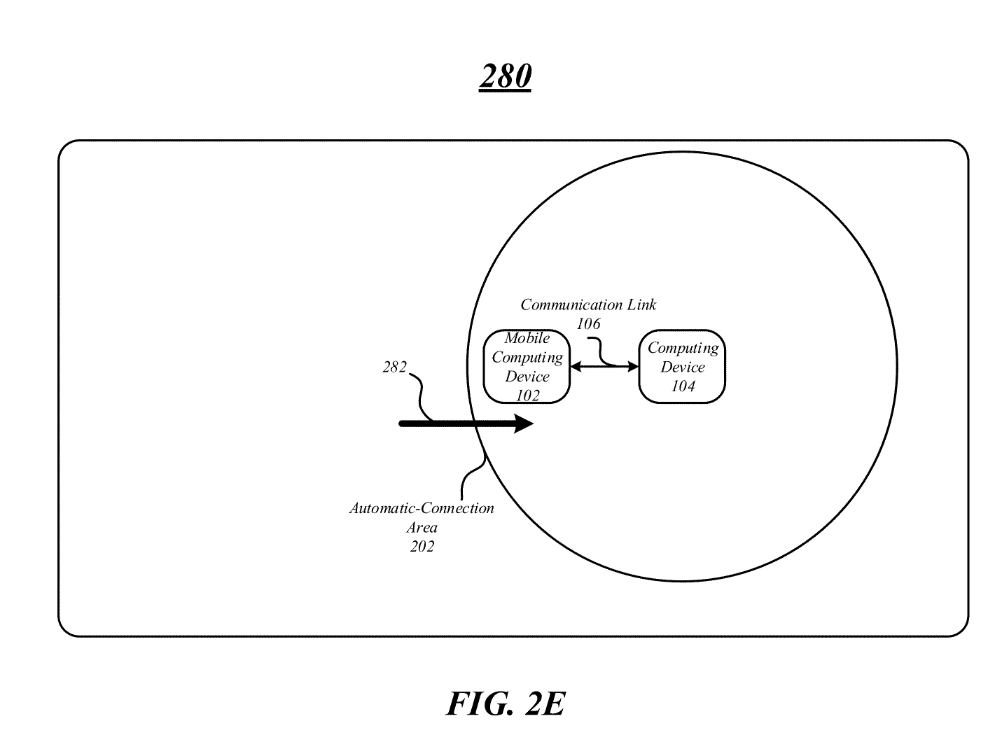

FIGS. 2A-2E illustrate various embodiments of a computing system 200 to establish and control a communication link between a mobile computing device 102 and a computing device 104 including automatic-connection operations. FIG. 2A illustrates an embodiment including the mobile computing device 102 and a computing device 104 within an automatic-connection area 202. The automatic-connection area 202 may be defined as any area in which the mobile computing device 102 may detect and/or establish a communication link 106 with the computing device 104. Further, the automatic-connection area may also be defined as any area in which the mobile computing device 102 may detect the presence of the computing device 104. The mobile computing device 102 may detect the presence of the computing device 104, including the detection of wireless signals.

In one example and as shown in FIG. 2B the mobile computing device 102 moves into the automatic-connection 202 by arrow 222. The mobile computing device 102 may detect wireless signals from the computing device 104. The mobile computing device 102 may then establish a communication link 106 with the computing device 104 if automatic-connection operation is enabled for the computing device 104. Further and although FIG. 2B illustrates the mobile computing device 102 moving towards the computing device 104, various embodiments are not limited in this manner and the computing device 104 may move such that the mobile computing device 102 detects the presence of the computing device 104. Further, the mobile computing device 102 can detect the presence of the computing device 104 via any type of detection means, including the detecting of wireless signals from the computing device 104, or using a proximity sensor to detect the computing device 104.

Once, the mobile computing device 102 detects the presence of the computing device 104, the mobile computing device 102 may perform an automatic-connection operation and a communication link 106 may be established between the mobile computing device 102 and computing device 104. Information may be communicated between the mobile computing device 102 and the computing device 104, as previously discussed.

Further and in some embodiments, the mobile computing device 102 may only perform the automatic-connection operation to establish the communication link 106 if automatic-connection is enabled for the computing device 104. If the automatic-connection operation is not enabled, the mobile computing device 102 will not automatically establish the communication link 106 with the computing device 104.

In some embodiments and as previously discussed, the automatic-connection operation may be disabled while the mobile computing device 102 is connected or coupled with the computing device 104 via a communication link 106. In these embodiments, the communication link 106 may be disconnected or broken between the mobile computing device 102 and computing device 104, as illustrated in FIG. 2C. When the automatic-connection operation is disabled for one or more computing devices 104 on the mobile computing device 102, the mobile computing device 102 will not automatically establish a communication link even if they are detected. However, the mobile computing device 102 may establish a communication link 106 with other computing devices 104 in which the automatic-connection is enabled.

In various embodiments, the automatic-connection operation on a mobile computing device 102 may be disabled (or enabled) in a number of different ways including a user input, configuration settings, trigger events and so forth. For example, a user may disable an automatic-connection operation via an input on a user interface. In another example, the automatic-connection operation may be disabled by a configuration settings, such as time of day, location, mode of operation and so forth. In a third example, a disabling trigger event may also be used to disable the automatic-connection operation, such as receiving or making a telephone call, receiving or sending an email, and so forth. Various embodiments are not limited in this manner, and the automatic-connection operation on a mobile computing device 102 may be disabled in any number of different ways.

The automatic-connection operation may remain disabled until a reset event occurs. As mentioned, the automatic-connection operation may be reset or enabled when the mobile computing device 102 exits (or reenters) an automatic-connection area 202, as illustrated in FIG. 2D at line 262. The mobile computing device 102 may determine that it has left the automatic-connection area 202 in a number of ways including failing to detect wireless signals from computing device 104, or failure to detect computing device 104 within proximity of the mobile computing device 102, for example. In this example, when the mobile computing device 102 reenters the automatic connection area 202, as illustrated in FIG. 2E at line 282, the communication link 106 may be established between the mobile computing device 102 and the computing device 104 via an automatic-connection operation.

Various embodiments are not limited to this example and in some embodiments, the reset event may not require the mobile computing device 102 to exit the automatic-connection area 202. In another example, the automatic-connection operation can be reset or enabled when the mobile computing device 102 changes a mode of operation, such as entering or exiting a lower power state when user interactions may be disabled. In a third example, the automatic-connection operation can be reset or enabled based on an occurrence of a reset event such as a time of day or an expiration of a time period. In a fourth example, the automatic-connection operation may be reset or enabled when the mobile computing device 102 is rebooted or shutdown. Various embodiments are not limited to these examples.

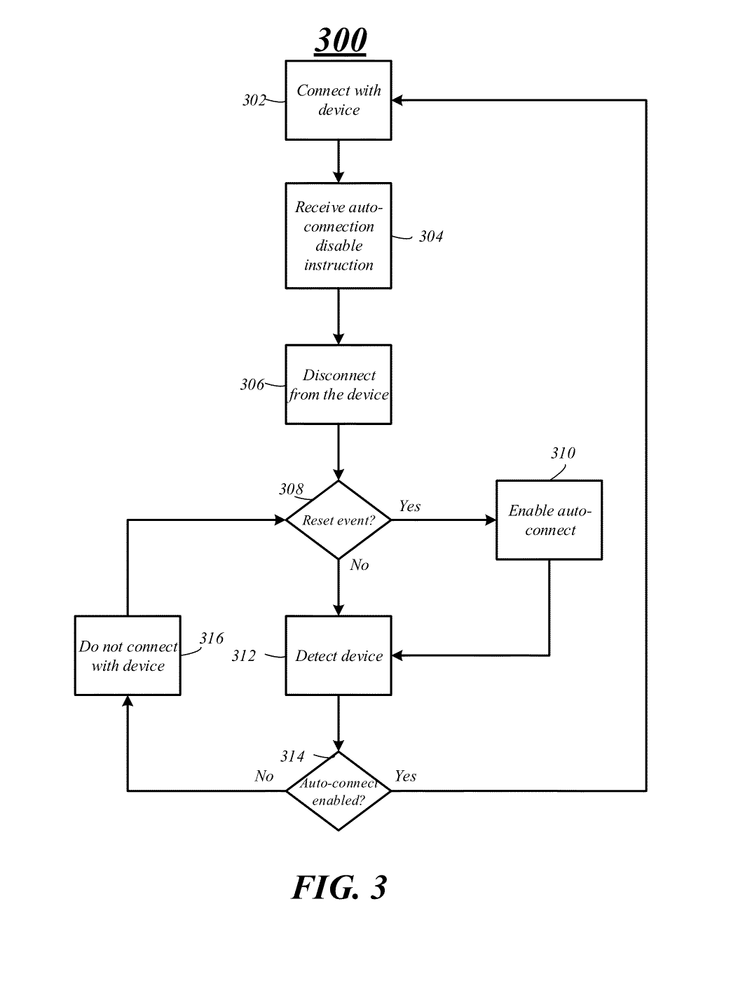

FIG. 3 illustrates an embodiment of a logic flow 300 to manage and control communication links including performing automatic-connection operations. In various embodiments, the logic flow 300 illustrated in FIG. 3 can be performed by any computing device including the mobile computing device 102 discussed above, for example. Further, although FIG. 3 illustrates the logic flow 300 having a number of blocks occurring in a particular order, various embodiments are not limited in this manner and other flows may be contemplated.

At block 302, a mobile computing device 102 may connect with another computing device 104 via a communication link 106. The connection can be established via an automatic-connection operation without user interaction. The mobile computing device 102 may communication any type of information with the other computing device 104. At block 304, the mobile computing device 102 may receive an automatic-connection disable instruction. As previously discussed, the automatic-connection operation may be disabled in any number of ways including user input, a trigger event, a location, a time, and so forth.

While the automatic-connection operation is disabled, the mobile computing device 102 will not automatically connect with the computing device 104 and will disconnect from the computing device 104 at block 306. In some embodiments, the mobile computing device 102 will disconnect from the computing device 104 by breaking or closing the communication link between the mobile computing device 102 and the other computing device 104. Even if the mobile computing device 102 detects the other computing device 104 once the communication link is disconnected, the mobile computing device 102 will not perform an automatic-connection operation to reconnect with the computing device 104 while the automatic-connection is disabled.

At block 308, the mobile computing device 102 may determine if a reset event has occurred. As mentioned, the reset event may be any event such as either device entering or exiting an automatic-connection area, a change in power state of either device, rebooting or shutting down of either device, an elapse of a time period, and so forth. If a reset event is not detected at block 308 and the computing device 104 is detected at block 312, the mobile computing device 102 will not connect with the computing device 104 at block 316. More specifically, a determination may be made at block 314 as to whether automatic-connection is enabled or not. If a reset event has not occurred or been detected at block 308, the automatic-connection will remain disabled and the logic flow 300 will proceed to block 316.

However, if a reset event is detected or determined to have occurred at block 308 the automatic-connection operation may be enabled at block 310. Thus, when the computing device 104 is detected at block 312 and a determination is made at block 314 the automatic connection operation will be enabled and the mobile computing device 102 will proceed with connecting with the computing device 104 as indicated by the logic flow 300 proceeding to block 302.

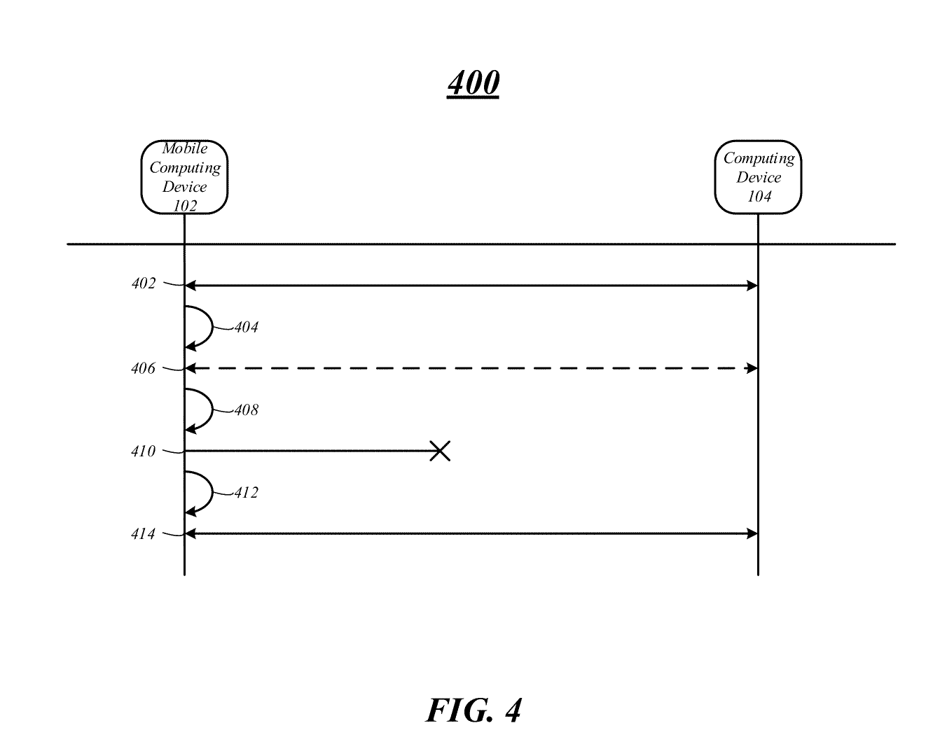

FIG. 4 illustrates an embodiment of a sequence diagram 400 for controlling a communication link and performing an automatic connection operation. Although FIG. 4 illustrates a certain sequence of events occurring in a particular order, various embodiments are not limited in this manner and some events may occur before or after other events.

In some embodiments, at line 402 a communication link 106 may be established between the mobile computing device 102 and the computing device 104. The communication link 106 may be used to communicate information between the devices. In embodiments, the mobile computing device 102 may establish the communication link 106 by performing an automatic-connection operation. For example, the mobile computing device 102 may automatically connect with the computing device 104 once it detects it within an automatic-connection area. As previously mentioned, the mobile computing device 102 may detect the computing device 104 in any number of ways including the detection of wireless signals or via a proximity sensor.

At line 404, the mobile computing device 102 may receive or detect an event or input to disable the automatic-connection operation between the mobile computing device 102 and the computing device 104. At line 406, the mobile computing device 102 may disconnect from the computing device 104 as indicated by the dashed line 406. The mobile computing device 102 may remain disconnected from the computing device 104 until a reset event occurs or is detected by the mobile computing device 102.

For example and at line 408, the mobile computing device 102 may detect the computing device 104, but will not establish a communication link 106 with the computing device 104 because the automatic-connection is disabled as illustrated by line 410. Once a reset event is detected by the mobile computing device 102, at line 412 for example, the mobile computing device 102 will reconnect with the computing device at line 414. Various embodiments are not limited in this manner.

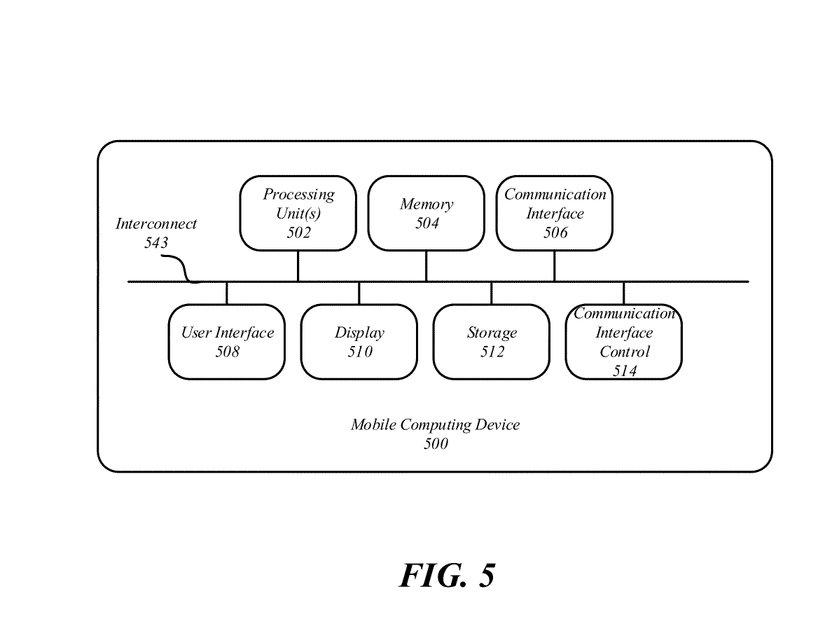

FIG. 5 illustrates an embodiment of a mobile computing device 500. In various embodiments, mobile computing device 500 may be representative of a computing device or system for use with one or more embodiments described herein, such as mobile computing device 102 and computing device 104 of FIGS. 1-4, the systems of FIGS. 2A-2E, logic flow 300 of FIG. 3, and sequence diagram 400 of FIG. 4.

In various embodiments, mobile computing device 500 may be any type of computing device including a computing device including a personal computer (PC), laptop computer, ultra-laptop computer, netbook computer, ultrabook computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device 500 also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device 500 may be implemented as a smart phone capable of executing computer applications, as well as voice communications and/or data communications. Although some embodiments may be described with a mobile computing device 500 implemented as a smart phone by way of example, it may be appreciated that other embodiments may be implemented using other wireless mobile computing devices as well. The embodiments are not limited in this context. In some embodiments, mobile computing device 500 may also be a vehicle navigation system, vehicle infotainment system, embedded in home appliances, etc.

As shown in FIG. 5, mobile computing device 500 may include multiple elements. One or more elements may be implemented using one or more circuits, components, registers, processors, software subroutine modules, or any combination thereof, as desired for a given set of design or performance constraints. Although FIG. 5 shows a limited number of elements in a certain topology by way of example, it can be appreciated that more or less elements in any suitable topology may be used in mobile computing device 500 as desired for a given implementation. The embodiments are not limited in this context.

In various embodiments, mobile computing device 500 may include a processing unit(s) 502. Processing unit(s) 502 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit or processing circuitry. The processing unit(s) 502 may be connected to and communicate with the other elements and components of the computing system via an interconnect 543, such as one or more buses, control lines, and data lines.

In one embodiment, mobile computing device 500 may include a memory 504 to couple to processing unit(s) 502. In various embodiments, the memory 504 may store data and information for use by the mobile computing device 500.

Memory 504 may be coupled to processing unit(s) 502 via interconnect 543, or by a dedicated communications bus between processing unit(s) 502 and memory component 102, as desired for a given implementation. Memory 504 may be implemented using any machine-readable or computer-readable media capable of storing data, including both volatile and non-volatile memory. In some embodiments, the machine-readable or computer-readable medium may include a non-transitory medium. The embodiments are not limited in this context.

The memory 504 can store instructions and data momentarily, temporarily, or permanently. The memory 504 may also store temporary variables or other intermediate information while the processing unit(s) 502 is executing instructions. The memory 504 is not limited to storing the above discussed data and may store any type of data.

The mobile computing device 500 may include a communication interface 506 which includes one or more components and circuitry to transmit and receive information using radio-frequency signals. More specifically, the communication interface 506 may include circuitry to produce radio-frequency mobile radio signals which are to be sent and for processing radio-frequency mobile radio signals which have been received. To this end, the communication interface 506 may be coupled to one or more antenna (not shown). The transmitted or received mobile radio signals are in one or more particular frequency ranges, which are typically prescribed by the mobile radio standard(s) supported by the radio-frequency assemblies. For example, communication interface 506 may include circuitry to process information according to one or more IEEE 802.11 standards. Various embodiments are not limited in this manner and communication interface 506 may transmit or receive information via any standard in any frequency range with one more devices.

In various embodiments, the communication interface 506 may be used to communicate with one or more other devices. The communication interface 506 may send and receive information from the computing devices as one or more packets, frames, and any other transmission structure in accordance with one or more protocols.

The mobile computing device 500 may include user interface 508 having at least one of an input device or sensor, such as one or more buttons, a keyboard, a keypad, a touchscreen display, a touch sensitive device, a microphone, a biometric finger printer reader, biometric eye scanner or any other device used for inputting information into mobile computing device 500. Moreover, the user interface 508 may be a sensor including any hardware or logic to detect one or more touches or inputs on or near a housing of the apparatus, a display of the apparatus including a touchscreen or touch sensitive display. The one or more inputs may occur separately, simultaneously and/or sequentially. The user interface 508 monitors touches that occur on the housing or display and produces signals indicative thereof. The user interface 508 may be used to input any information or data into the mobile computing device 500. For example, the user interface 508 may detect or receive a user input to disable (or enable) an automatic-connection operation on the mobile computing device 500.

In various embodiments, the user interface 508 may include one or more components to output information to a user. For example, the user interface 508 may include a speaker to output an audible noise or a haptic feedback device to output a vibration. The user interface 508 may be located any within or on mobile computing device 500, or may be separate and connected to the mobile computing device 500 via a wired or wireless connection.

The mobile computing device 500 may also include storage 512. Storage 512 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 512 may include technology to increase the storage performance enhanced protection for valuable digital media when multiple hard drives are included, for example. Further examples of storage 512 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

The mobile computing device 500 may include a communication interface control component 514 to control and manage various aspects of communication interface including establishing communication links between computing devices, performing automatic-connection operations, controlling (enabling/disabling) automatic-connection operations, and so forth.

More specifically, the communication interface control component 514 may establish a communication link between the mobile computing device 500 and another device. In some embodiments, the communication interface control component 514 may perform an automatic-connection operation to automatically connect with the device once it is detected in an automatic-connection area. An automatic-connection operation may include communicating information between the mobile computing device 500 and another device without any user interaction. The information may include identify information, password information, protocol information and any other type of information used to establish a communication link between the devices. Further, the communication interface control component 514 may use and control the communication interface 506 to establish the communication link.

Moreover, the communication interface control component 514 may also control various aspects of the automatic-connection operation including disabling and enabling the operation for one or more devices. In some embodiments, based on user input, a trigger event, time of day, and so forth, the communication interface control component 514 may disable (or enable) the automatic-connection operation, for example. When automatic-connection operation is disabled for another device, a communication link will not automatically be established between the mobile computing device 500 and other device.

In embodiments, the automatic-connection operation may be disabled for some devices and enabled for other devices. In other words, the communication interface control component 514 may automatically connect with one, but not automatically connect with another device based whether the automatic-connection operation is enabled or disabled. Thus, the automatic-connection operation can be enabled or disabled on a device-by-device basis and stored as a configuration setting. Various embodiments are not limited in this manner.

The communication interface control component 514 may also control various aspects of the communication link. For example, when the mobile computing device 500 has an already established communication link with another device and automatic-connection is disabled for that device, the communication interface control component 514 may close the communication link with that device, e.g. the mobile computing device 500 will disconnect from the other device such that information cannot be communicated between them. In the case when an automatic-connection operation is disabled for a particular device prior to a communication link being established between that device and the mobile computing device 500, a communication link will not be established.

The communication interface control component 514 may also reset or enable an automatic-connection operation for a particular based on detection of a trigger or reset event. As previously discussed, a reset event may be any type of event including, but not limited to, leaving (or reentering) an automatic-connection area, changing a mode of operation for either device, changing a power state for either device, the expiration of a time period, a particular time of day, and so forth. Various embodiments are not limited in this manner. Once the automatic-connection operation is enabled for the device, the mobile computing device 500 may automatically establish a communication link with that device.

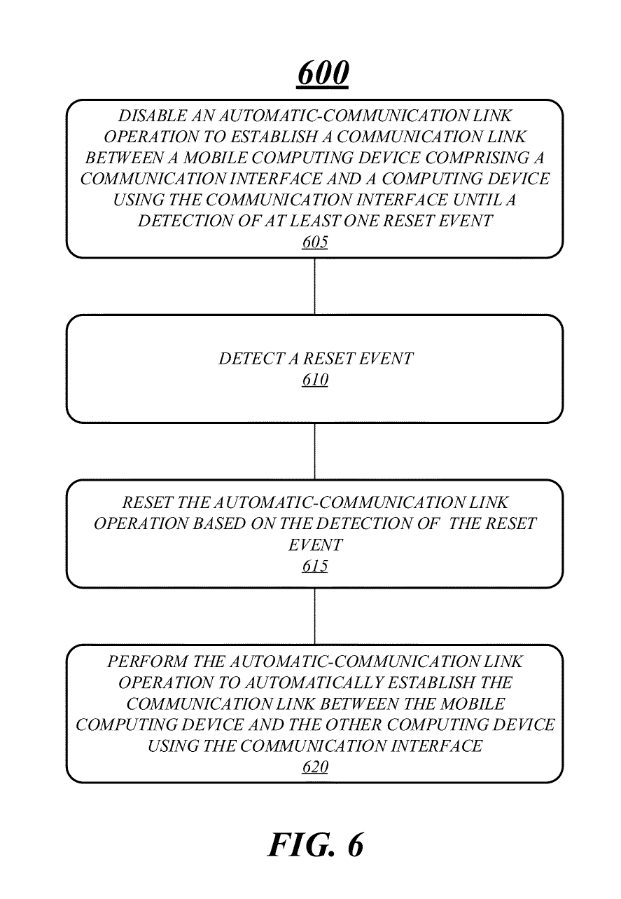

FIG. 6 illustrates an embodiment of a logic flow diagram 600. The logic flow 600 may be representative of some or all of the operations executed by one or more embodiments described herein. For example, the logic flow 600 may illustrate operations performed by the mobile computing device 102 and computing device 104.

In the illustrated embodiment shown in FIG. 6, the logic flow 600 may include disabling an automatic-communication link operation to establish a communication link between a mobile computing device comprising a communication interface and a computing device using the communication interface until a detection of at least one reset event at block 605. As mentioned, the automatic-communication link operation may be disabled in a number of different ways, and when disabled for a particular device, a mobile computing device will not automatically establish a connection or communication link with the particular device. The automatic-communication link operation may be disabled prior to, during, or after the establishment of a communication link. If a communication link is currently established, the mobile computing device may disconnect from the particular device.

The logic flow 600 may also include detecting at least one reset event at block 610 and resetting the automatic-communication link operation based on the detection of at least reset event at block 615. Once the automatic-communication link operation is enabled or reset, the mobile computing device may automatically connect with the particular device. More specifically, at block 620 the logic flow 600 can include performing the automatic-communication link operation to automatically establish the communication link between the mobile computing device and the other computing device using the communication interface.

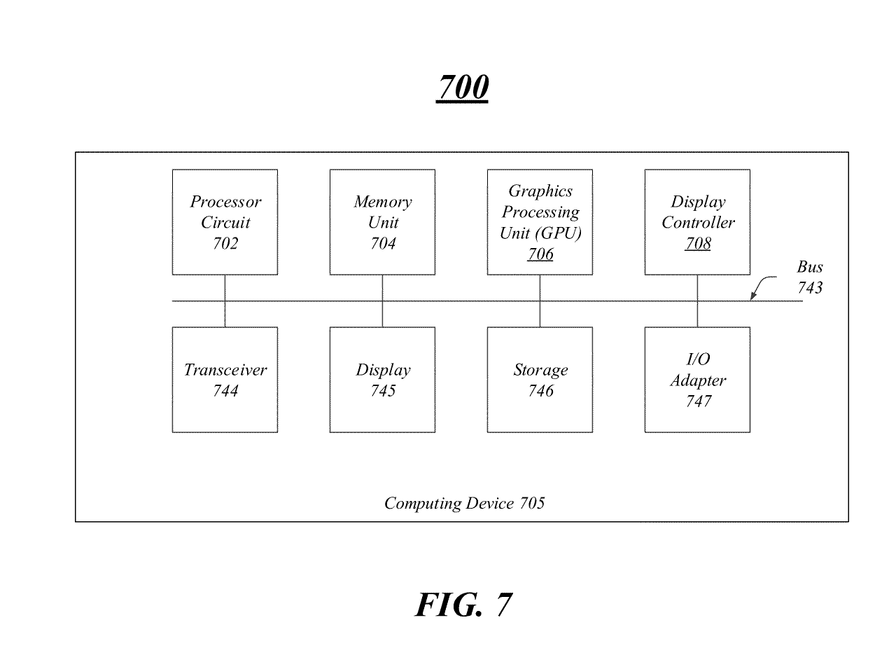

FIG. 7 illustrates one embodiment of a system 700. In various embodiments, system 700 may be representative of a system or architecture suitable for use with one or more embodiments described herein, such a computing device 104. The embodiments are not limited in this respect.

As shown in FIG. 7, system 700 may include multiple elements. One or more elements may be implemented using one or more circuits, components, registers, processors, software subroutines, modules, or any combination thereof, as desired for a given set of design or performance constraints. Although FIG. 7 shows a limited number of elements in a certain topology by way of example, it can be appreciated that more or less elements in any suitable topology may be used in system 700 as desired for a given implementation. The embodiments are not limited in this context.

In various embodiments, system 700 may include a computing device 705 which may be any type of computer or processing device including a personal computer, desktop computer, tablet computer, netbook computer, notebook computer, laptop computer, server, server farm, blade server, or any other type of server, and so forth.

Other examples of computing device 705 also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a computing device 705 may be implemented as a smart phone capable of executing computer applications, as well as voice communications and/or data communications. Although some embodiments may be described with a computing device 705 implemented as a smart phone by way of example, it may be appreciated that other embodiments may be implemented using other wireless computing devices as well. The embodiments are not limited in this context.

In various embodiments, computing device 705 may include processor circuit 702. Processor circuit 702 may be implemented using any processor or logic device. The processing circuit 702 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing circuit 702 may be connected to and communicate with the other elements of the computing system via an interconnect 743, such as one or more buses, control lines, and data lines.

In one embodiment, computing device 705 may include a memory unit 704 to couple to processor circuit 702. Memory unit 704 may be coupled to processor circuit 702 via communications bus 743, or by a dedicated communications bus between processor circuit 702 and memory unit 704, as desired for a given implementation. Memory unit 04 may be implemented using any machine-readable or computer-readable media capable of storing data, including both volatile and non-volatile memory. In some embodiments, the machine-readable or computer-readable medium may include a non-transitory medium. The embodiments are not limited in this context.

Computing device 705 may include a graphics processing unit (GPU) 706, in various embodiments. The GPU 706 may include any processing unit, logic or circuitry optimized to perform graphics-related operations as well as the video decoder engines and the frame correlation engines. The GPU 706 may be used to render 2-dimensional (2-D) and/or 3-dimensional (3-D) images for various applications such as video games, graphics, computer-aided design (CAD), simulation and visualization tools, imaging, etc. Various embodiments are not limited in this manner; GPU 706 may process any type of graphics data such as pictures, videos, programs, animation, 3D, 2D, objects images and so forth.

In some embodiments, computing device 705 may include a display controller 708. Display controller 708 may be any type of processor, controller, circuit, logic, and so forth for processing graphics information and displaying the graphics information. The display controller 708 may receive or retrieve graphics information from one or more buffers. After processing the information, the display controller 708 may send the graphics information to a display.

In various embodiments, system 700 may include a transceiver 744. Transceiver 744 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 744 may operate in accordance with one or more applicable standards in any version. The embodiments are not limited in this context.

In various embodiments, computing device 705 may include a display 745. Display 745 may constitute any display device capable of displaying information received from processor circuit 702, graphics processing unit 706 and display controller 708.

In various embodiments, computing device 705 may include storage 746. Storage 746 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 746 may include technology to increase the storage performance enhanced protection for valuable digital media when multiple hard drives are included, for example. Further examples of storage 746 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, computing device 705 may include one or more I/O adapters 747. Examples of I/O adapters 747 may include Universal Serial Bus (USB) ports/adapters, IEEE 1394 Firewire ports/adapters, and so forth. The embodiments are not limited in this context.

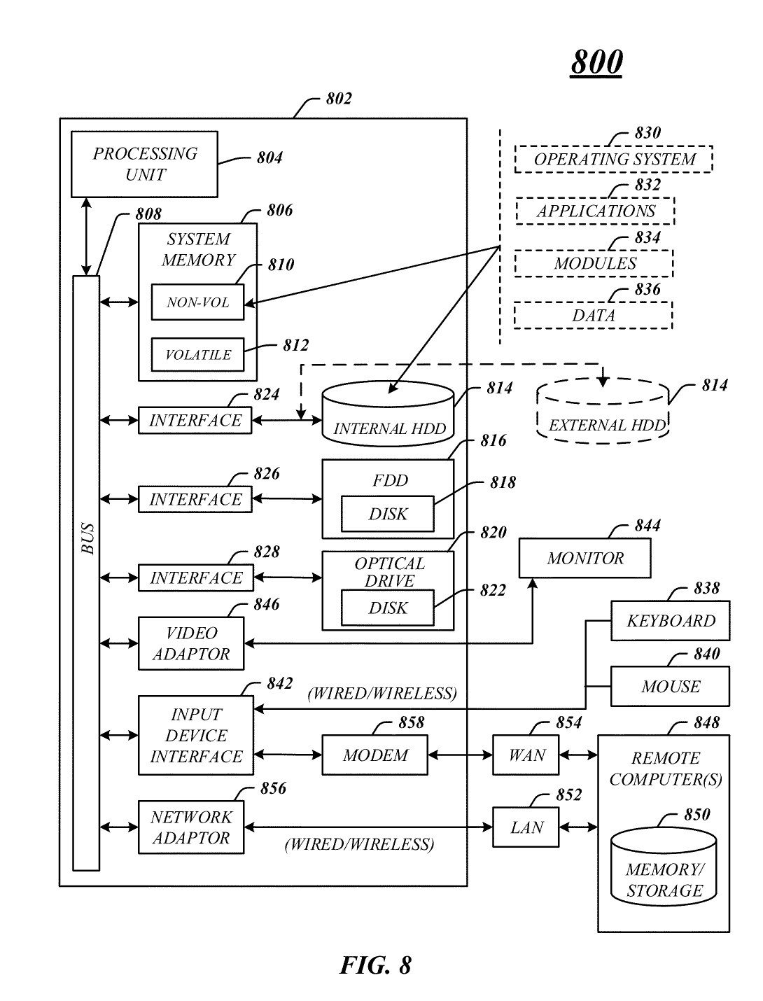

FIG. 8 illustrates an embodiment of an exemplary computing architecture 800 suitable for implementing various embodiments as previously described. In one embodiment, the computing architecture 800 may include or be implemented as part of mobile computing device 102 and/or computing device 104.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 includes a processing unit 804, a system memory 806 and a system bus 808. The processing unit 804 can be any of various commercially available processors.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the computing devices 102 and 104.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the systems 100, 200, 1100 and 800 as previously described with reference to FIGS. 1-12 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through thirtieth (1-30) provided below are intended to be exemplary and non-limiting.

In a first example, a mobile computing device, a system or an apparatus can include a memory, a processing unit, a communication interface, and a communication interface control component executable by the processing unit to disable an automatic-connection operation to establish a communication link using the communication interface until a detection of at least one reset event, reset the automatic-connection operation based on the detection of a reset event, and perform the automatic-connection operation to automatically establish the communication link using the communication interface.

In a second example and in furtherance of the first example, the mobile computing device, the system or the apparatus can include the reset event comprising one of a change in power states, an entry or exit of a standby mode of operation, an exit or entry into an automatic-connection area, or an expiration of a time period.

In a third example and in furtherance of any of the previous examples, the mobile computing device, the system or the apparatus can include the automatic-connection area comprising an area in which the mobile computing device wirelessly detects the other computing device via the communication interface.

In a fourth example and in furtherance of any of the previous examples, the mobile computing device, the system or the apparatus can include a user interface to receive one or more user inputs and the communication interface control component to disable the automatic-communication operation based on the one or more user inputs.

In a fifth example and in furtherance of any of the previous examples, the mobile computing device, the system or the apparatus can include the communication interface control component to disconnect a communication link with another computing device based on the one or more user inputs.

In a sixth example and in furtherance of any of the previous examples, the mobile computing device, the system or the apparatus can include the communication interface control component to disable the automatic-connection operation for an established communication link between the mobile computing device and another computing device, and disconnect the established communication link.

In a seventh example and in furtherance of any of the previous examples, the mobile computing device, the system or the apparatus can include the communication interface control component to automatically establish the communication link with a computing device comprising one of a docking station, a keyboard, or a monitor.

In an eighth example and in furtherance of any of the previous examples, the mobile computing device, the system or the apparatus can include the communication interface control component to disable the automatic-connection operation for an established communication link between the mobile computing device and another computing device, and disconnect the established communication link.

In a ninth example and in furtherance of any of the previous examples, the mobile computing device, the system or the apparatus can include the communication link in accordance of a communication standard comprising one of Institute of Electrical and Electronics Engineers (IEEE) 802.11ad, IEEE 802.11ac, and Bluetooth.

In a tenth example and in furtherance of any of the previous examples, an article comprising a non-transitory computer-readable storage medium comprising a plurality of instructions that when executed enable processing circuitry to disable an automatic-connection operation to establish a communication link between a mobile computing device comprising a communication interface and a computing device using the communication interface until a detection of at least one reset event, detect a reset event, reset the automatic-connection operation based on the detection the reset event, and perform the automatic-connection operation to automatically establish the communication link between the mobile computing device and the other computing device using the communication interface.

In an eleventh example and in furtherance of any of the previous examples, the non-transitory computer-readable storage medium, may include the reset event comprising one of a change in power states, an entry or exit of a standby mode of operation, an exit or entry into an automatic-connection area, and an expiration of a time period.

In a twelfth example and in furtherance of any of the previous examples, the non-transitory computer-readable storage medium, may include the automatic-connection area comprising an area in which the mobile computing device wirelessly detects the other computing device.

In a thirteenth example and in furtherance of any of the previous examples, the non-transitory computer-readable storage medium, further comprising the plurality of instructions that when executed enable processing circuitry to receive one or more user inputs, and disable the automatic-connection operation based on the one or more user inputs.

In a fourteenth example and in furtherance of any of the previous examples, the non-transitory computer-readable storage medium, further comprising the plurality of instructions that when executed enable processing circuitry to disconnect a communication link with another computing device based on the one or more user inputs.

In a fifteenth example and in furtherance of any of the previous examples, the non-transitory computer-readable storage medium, further comprising the plurality of instructions that when executed enable processing circuitry to disable the automatic-connection operation for an established communication link between the mobile computing device and another computing device, and disconnect the established communication link.

In a sixteenth example and in furtherance of any of the previous examples, the non-transitory computer-readable storage medium, further comprising the plurality of instructions that when executed enable processing circuitry to automatically establish the communication link with a computing device comprising one of a docking station, a keyboard, or a monitor.

In a seventeenth example and in furtherance of any of the previous examples, the non-transitory computer-readable storage medium, further comprising the plurality of instructions that when executed enable processing circuitry to disable the automatic-connection operation to establish the communication link using the communication interface with a particular computing device while permitting a communication link using the communication interface with one or more other computing devices.

In an eighteenth example and in furtherance of any of the previous examples, a method may include disabling, by processing circuitry, an automatic-connection operation to establish a communication link between a mobile computing device comprising a communication interface and a computing device using the communication interface until a detection of at least one reset event. The method may include detecting a reset event, resetting the automatic-connection operation based on the detection of the reset event; and performing the automatic-connection operation to automatically establish the communication link between the mobile computing device and the other computing device using the communication interface.

In a nineteenth example and in furtherance of any of the previous examples, a method may include the reset event comprising a change in power states, an exit of a standby mode of operation, a reentry into an automatic-connection area, an exit of an automatic-connection area, or an expiration of a time period.

In a twentieth example and in furtherance of any of the previous examples, a method may include the automatic-connection area comprising an area in which the mobile computing device wirelessly detects the other computing device.

In a twenty-first example and in furtherance of any of the previous examples, a method may include receiving one or more user inputs and disabling the automatic-connection operation based on the one or more user inputs.

In a twenty-second example and in furtherance of any of the previous examples, a method may include disconnecting a communication link with another computing device based on the one or more user inputs.

In a twenty-third example and in furtherance of any of the previous examples, a method may disabling the automatic-connection operation for an established communication link between the mobile computing device and another computing device and disconnecting the established communication link.

In a twenty-fourth example and in furtherance of any of the previous examples, a method may include automatically establishing the communication link with a computing device comprising one of a docking station, a keyboard, or a monitor.

In a twenty-fifth example and in furtherance of any of the previous examples, a method may disabling, by the processing circuitry, the automatic-connection operation to establish the communication link using the communication interface with a particular computing device while permitting a communication link using the communication interface with one or more other computing devices.

In a twenty-sixth example and in furtherance of any of the previous examples, an apparatus or device may include means for means for disabling an automatic-connection operation to establish a communication link between a mobile computing device comprising a communication interface and a computing device using the communication interface until a detection of at least one reset event, means for detecting a reset event, means for resetting the automatic-connection operation based on the detection the reset event, and means for performing the automatic-connection operation to automatically establish the communication link between the mobile computing device and the other computing device using the communication interface.

In a twenty-seventh example and in furtherance of any of the previous examples, an apparatus or device may include means for receiving one or more user inputs, and disable the automatic-connection operation based on the one or more user inputs.

In a twenty-eighteenth example and in furtherance of any of the previous examples, an apparatus or device may include means for disconnecting a communication link with another computing device based on the one or more user inputs.

In a twenty-nineteenth example and in furtherance of any of the previous examples, an apparatus or device may include means for disabling the automatic-connection operation for an established communication link between the mobile computing device and another computing device, and disconnect the established communication link.

In a thirtieth example and in furtherance of any of the previous examples, an apparatus or device may include means for disabling the automatic-connection operation to establish the communication link using the communication interface with a particular computing device while permitting a communication link using the communication interface with one or more other computing devices.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A mobile computing device, comprising:
a memory;
a processing unit;
a communication interface; and
a communication interface control component executable by the processing unit to disable an automatic-connection operation to establish a communication link using the communication interface until a detection of at least one reset event, reset the automatic-connection operation based on the detection of a reset event, and perform the automatic-connection operation to automatically establish the communication link using the communication interface.

2. The mobile computing device of claim 1, the reset event comprising one of a change in power states, an entry or exit of a standby mode of operation, an exit or entry into an automatic-connection area, or an expiration of a time period.

3. The mobile computing device of claim 2, the automatic-connection area comprising an area in which the mobile computing device wirelessly detects the other computing device via the communication interface.

4. The mobile computing device of claim 1, comprising:
a user interface to receive one or more user inputs;
the communication interface control component to disable the automatic-communication operation based on the one or more user inputs.

5. The mobile computing device of claim 4, the communication interface control component to disconnect a communication link with another computing device based on the one or more user inputs.

6. The mobile computing device of claim 1, the communication interface control component to disable the automatic-connection operation for an established communication link between the mobile computing device and another computing device, and disconnect the established communication link.

7. The mobile computing device of claim 1, the communication interface control component to automatically establish the communication link with a computing device comprising one of a docking station, a keyboard, or a monitor.

8. The mobile computing device of claim 1, the communication interface control component to disable the automatic-connection operation to establish the communication link using the communication interface with a particular computing device while permitting an establishment of a communication link using the communication interface with one or more other computing devices.

9. The mobile computing device of claim 1, wherein the communication link is in accordance of a communication standard comprising one of Institute of Electrical and Electronics Engineers (IEEE) 802.11ad, IEEE 802.11ac, and Bluetooth.

10. An article comprising a non-transitory computer-readable storage medium comprising a plurality of instructions that when executed enable processing circuitry to:
disable an automatic-connection operation to establish a communication link between a mobile computing device comprising a communication interface and a computing device using the communication interface until a detection of at least one reset event;
detect a reset event;
reset the automatic-connection operation based on the detection the reset event; and
perform the automatic-connection operation to automatically establish the communication link between the mobile computing device and the other computing device using the communication interface.

11. The non-transitory computer-readable storage medium of claim 10, the reset event comprising one of a change in power states, an entry or exit of a standby mode of operation, an exit or entry into an automatic-connection area, and an expiration of a time period.

12. The non-transitory computer-readable storage medium of claim 11, the automatic-connection area comprising an area in which the mobile computing device wirelessly detects the other computing device.

13. The non-transitory computer-readable storage medium of claim 10, further comprising the plurality of instructions that when executed enable processing circuitry to receive one or more user inputs, and disable the automatic-connection operation based on the one or more user inputs.

14. The non-transitory computer-readable storage medium of claim 13, further comprising the plurality of instructions that when executed enable processing circuitry to disconnect a communication link with another computing device based on the one or more user inputs.

15. The non-transitory computer-readable storage medium of claim 10, further comprising the plurality of instructions that when executed enable processing circuitry to disable the automatic-connection operation for an established communication link between the mobile computing device and another computing device, and disconnect the established communication link.

16. The non-transitory computer-readable storage medium of claim 10, further comprising the plurality of instructions that when executed enable processing circuitry to automatically establish the communication link with a computing device comprising one of a docking station, a keyboard, or a monitor.

17. The non-transitory computer-readable storage medium of claim 10, further comprising the plurality of instructions that when executed enable processing circuitry to disable the automatic-connection operation to establish the communication link using the communication interface with a particular computing device while permitting a communication link using the communication interface with one or more other computing devices.

18. A computer-implemented method, comprising:
disabling, by processing circuitry, an automatic-connection operation to establish a communication link between a mobile computing device comprising a communication interface and a computing device using the communication interface until a detection of at least one reset event;
detecting, by the processing circuitry, a reset event;
resetting, by the processing circuitry, the automatic-connection operation based on the detection of the reset event; and
performing, by the processing circuitry, the automatic-connection operation to automatically establish the communication link between the mobile computing device and the other computing device using the communication interface.

19. The computer-implemented method of claim 18, the reset event comprising a change in power states, an exit of a standby mode of operation, a reentry into an automatic-connection area, an exit of an automatic-connection area, or an expiration of a time period.

20. The computer-implemented method of claim 19, the automatic-connection area comprising an area in which the mobile computing device wirelessly detects the other computing device.

21. The computer-implemented method of claim 18, comprising:
receiving, via a user interface, one or more user inputs;
disabling, by the processing circuitry, the automatic-connection operation based on the one or more user inputs.

22. The computer-implemented method of claim 21, comprising:
disconnecting, by the processing circuitry, a communication link with another computing device based on the one or more user inputs.

23. The computer-implemented method of claim 18, comprising:
disabling, by the processing circuitry, the automatic-connection operation for an established communication link between the mobile computing device and another computing device; and
disconnecting, by the processing circuitry, the established communication link.

24. The computer-implemented method of claim 18, comprising:
automatically establishing, by the processing circuitry, the communication link with a computing device comprising one of a docking station, a keyboard, or a monitor.

25. The computer-implemented method of claim 18, comprising:
disabling, by the processing circuitry, the automatic-connection operation to establish the communication link using the communication interface with a particular computing device while permitting a communication link using the communication interface with one or more other computing devices.
